(19) United States
(12) Patent Application Publication
(10) Pub. No.: US 2004/0203680 A1
(43) Pub. Date: Oct. 14, 2004

(54) Integrated wireline and wireless service

(75) Inventor: Dany Sylvain, Gatineau (CA)

Correspondence Address: WITHROW & TERRANOVA, P.L.L.C., P.O. BOX 1287, CARY, NC, 27512, US

(73) Assignee: NORTEL NETWORKS LIMITED, St. Laurent (CA)

(21) Appl. No.: 10/409,280

(22) Filed: Apr. 8, 2003

(51) Int. Cl. H04M 3/42

(52) U.S. Cl. 455/417; 455/422.1

(57) ABSTRACT

The present invention relates to routing incoming calls to a single mobile terminal through either a wireless network or the PSTN via a terminal adapter, which is capable of wirelessly communicating with the mobile terminal. The mobile terminal may facilitate cellular calls via the wireless network, or PSTN calls via the terminal adapter. The terminal adapter monitors its ability to communicate with the mobile terminal, and provides such information to a service node, which controls whether incoming calls intended for the mobile terminal are routed through the wireless network or the PSTN. When the mobile terminal is within a communication zone of the terminal adapter, the service node routes incoming calls to the mobile terminal through the PSTN via the terminal adapter. When the mobile terminal is outside of the communication zone, the service node will route the incoming call to the mobile terminal through the wireless network.

### FIELD OF THE INVENTION

The present invention relates to mobile communications, and in particular to allowing a single mobile terminal to communicate over cellular networks as well as the public switched telephone network via a wireless interface.

### BACKGROUND OF THE INVENTION

Today's telephony users generally have at least one wireline-based telephone receiving services through the public switched telephone network (PSTN) and a mobile telephone receiving services through a cellular network. These wireline and mobile telephones are incompatible, and thus incapable of facilitating communications over both the cellular and public switched networks. As such, telephony users must juggle multiple telephone terminals, using one terminal to make and receive calls via the cellular network, and another to make and receive calls via the PSTN. In addition to the user having to keep track of multiple telephones, incoming calls are generally free through the service providers of the PSTN, while cellular service providers charge for such incoming calls. Accordingly, there is a need for a technique to allow a single telephony device to interface with both the cellular network and the PSTN in an effective and efficient manner. There is a further need to automatically direct calls via the PSTN when the telephony device is capable of terminating the incoming call via the PSTN, and terminate the call via the cellular network when termination via the PSTN is not possible.

### SUMMARY OF THE INVENTION

The present invention relates to routing incoming calls to a single mobile terminal through either a wireless network or the public switched telephone network (PSTN) via a terminal adapter, which is capable of wirelessly communicating with the mobile terminal. As such, the mobile terminal may facilitate traditional cellular calls via the wireless network, or traditional PSTN calls via the terminal adapter. The terminal adapter monitors its ability to communicate with the mobile terminal, and provides such information to a service node, which controls whether incoming calls directed to the mobile terminal are routed through the wireless network or the PSTN. When the mobile terminal is within an acceptable communication zone associated with the terminal adapter, the service node will route incoming calls to the mobile terminal through the PSTN via the terminal adapter. When the mobile terminal is outside of the communication zone of the terminal adapter, the service node will route the incoming call to the mobile terminal through the wireless network.

In one embodiment, the mobile terminal has two directory numbers, one associated with access via the wireless network and one associated with access via the PSTN. Accordingly, calls directed to either of the directory numbers may be routed through the wireless network or the PSTN, depending on the location of the mobile terminal or the ability of the terminal adapter to communicate with the mobile terminal. In essence, incoming calls directed to either of the directory numbers associated with the mobile terminal are automatically routed through the appropriate communication network based on whether the mobile terminal can communicate via the PSTN.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a communication environment according to one embodiment of the present invention.

FIGS. 2A and 2B provide a communication call flow diagram wherein an incoming call cannot be terminated via the public switched telephone network.

FIGS. 3A and 3B provide a communication call flow diagram wherein an incoming call can be terminated via the public switched telephone network.

FIG. 4 is a block representation of a terminal adapter according to one embodiment of the present invention.

FIG. 5 is a block representation of a service node according to one embodiment of the present invention.

FIG. 6 is a block representation of a mobile terminal according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention relates to providing a mobile terminal that is capable of communication via a cellular-based wireless network, as well as the public switched telephone network (PSTN) through a terminal adapter. The terminal adapter is coupled to the PSTN in traditional fashion, and communicates wirelessly with the mobile terminal using local wireless access technology, such as traditional analog and digital cordless technologies, 802.11 wireless local area network technologies, and Bluetooth technology. Accordingly, the mobile terminal may be associated with one directory number for cellular access, and another for PSTN access. Communications with the wireless network can use any available cellular access technology, such as time division multiple access, code division multiple access, and orthogonal frequency division multiple access.

In addition to connecting to the PSTN and providing wireless access for the mobile terminal, the terminal adapter may have a data interface through which the terminal adapter can communicate with a service node, which controls the routing of incoming calls directed to either of the directory numbers associated with the mobile terminal. The terminal adapter will determine when the mobile terminal is within a zone in which communication via the local wireless access technology is possible, and provide information to the service node bearing on whether the mobile terminal is within or outside of the zone. The service node will take this information and direct incoming calls to the PSTN directory number for the mobile terminal associated with the terminal adapter when the mobile terminal is within the zone, and direct calls to the directory number associated with the wireless network when the mobile terminal is outside of the zone. Accordingly, the present invention effectively routes call through the wireless network or through the PSTN to a terminal adapter, depending on whether the terminal adapter can effectively communicate with the mobile terminal. The wireless network is preferably a cellular network and can be based on technology such as TDMA, CDMA, UMTS, OFDM, and GSM.

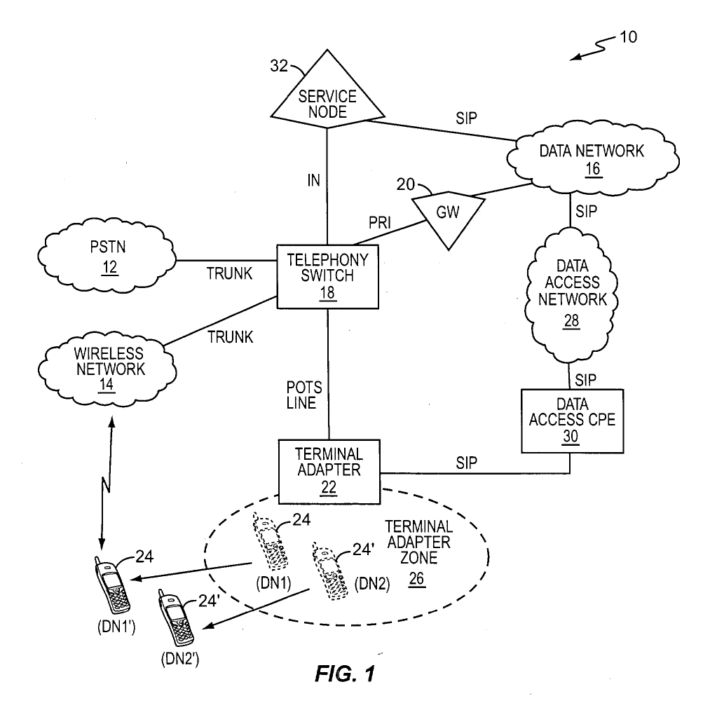

With reference to FIG. 1, a communication environment 10 is illustrated as including the PSTN 12, a cellular-based wireless network 14, and a packet-switched data network 16. Central to these networks is a telephony switch 18, which effectively connects to the PSTN 12 and the wireless network 14 via telephony trunks, and to the data network 16 via a gateway 20. The interface with the gateway 20 is typically a Primary Rate Interface, but those skilled in the art will recognize other applicable interfaces. Further, the gateway 20 will operate to convert circuit-switched communications to packet-based communications as necessary for carrying voice as well as facilitating signaling, when necessary. Those skilled in the art will recognize that the telephony switch 18 can be based on time division multiplex (TDM) or packet technology. The telephony switch 18 can also be a Public Branch Exchange (PBX). The telephony switch 18 provides a direct interface to a user via a traditional telephone line, based on analog or digital technology, and can carry one or many simultaneous calls.

For the present invention, the user will have a terminal adapter 22, which interfaces with the telephone line and facilitates wireless communications with the user's mobile terminal 24. Accordingly, for an incoming or outgoing call via the telephone line, the terminal adapter 22 will provide a circuit-switched interface to the telephone line and a wireless interface to the mobile terminal 24, wherein the mobile terminal 24 operates analogously to a traditional cordless residential telephone. Further, the terminal adapter 22 is capable of supporting multiple mobile terminals 24′, as illustrated.

The wireless interface provided by the terminal adapter 22 will have a limited range, and as such, will provide a terminal adapter zone 26, which defines an area or range in which communications between the terminal adapter 22 and the mobile terminal 24 are possible. The terminal adapter 22, through a variety of possible techniques, will determine whether the mobile terminal 24 is within the terminal adapter zone 26, and provide information bearing on the presence of the mobile terminal 24 through a data access network 28 and local data access customer premise equipment (CPE) 30 to a service node 32. The data access CPE 30 may be a cable modem, DSL modem, ISDN modem, or like communication terminal that provides access to the data network 16 via the corresponding cable network, DSL network, or IDSN forming the data access network 28.

The service node 32 is configured to interact with the telephony switch 18 via a network and any necessary translation devices (not shown) to assist in routing incoming calls directed to the mobile terminal 24. Preferably, communications with the telephony switch 18 use Intelligent Network (IN) signaling, and communications with the terminal adapter 22 are implemented using the Session Initiation Protocol (SIP); however, those skilled in the art will recognize the applicability of alternative signaling technologies and protocols.

Incoming calls to the PSTN directory number (DN1) are routed to the telephony switch 18, which is provisioned to access the service node 32 to determine how to further route the call for termination. The service node 32 will receive a message from the telephony switch 18 identifying the directory number associated with the called party for the incoming call. From the directory number, the service node 32 will recognize that the directory number is the directory number associated with the mobile terminal 24. The service node 32 will determine whether the mobile terminal 24 is within the terminal adapter zone 26 of the terminal adapter 22 based on a query to the terminal adapter 22 or information provided by the terminal adapter 22 on a periodic basis. If the mobile terminal 24 is within the terminal adapter zone 26, the service node 32 will send a message to the telephony switch 18 directing the telephony switch 18 to route the incoming call to the mobile terminal 24 via the terminal adapter 22 using the PSTN directory number (DN1). If the mobile terminal 24 is not within the terminal adapter zone 26, the service node 32 will instruct the telephony switch 18 to route the call to the mobile terminal 24 through the wireless network 14 using the cellular directory number (DN1′). Similar operation is provided for other mobile terminals 24′, which may have other PSTN directory numbers (DN2) and cellular directory numbers (DN2′).

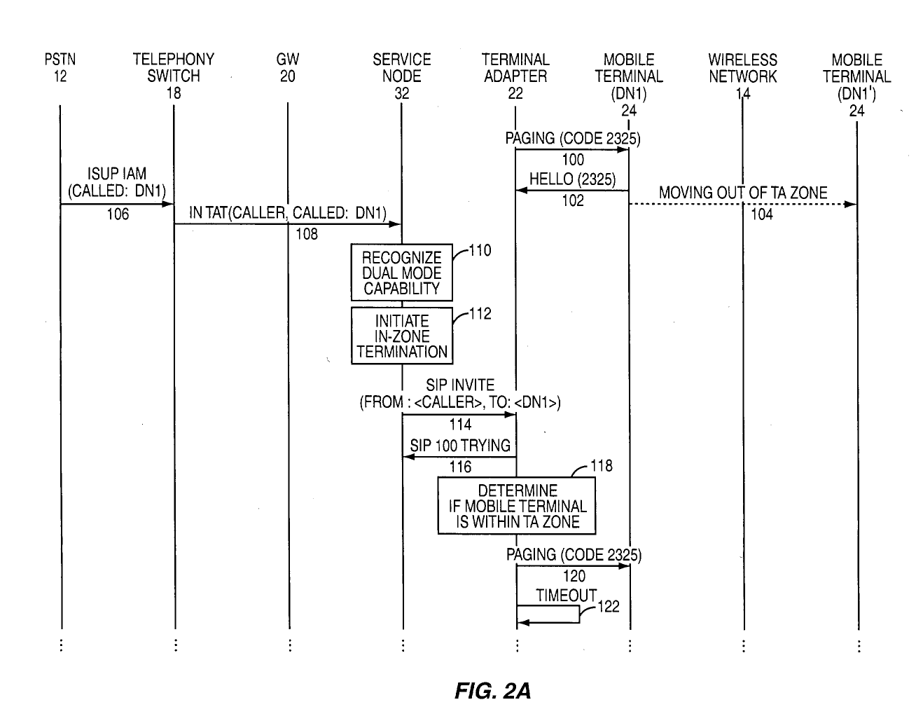

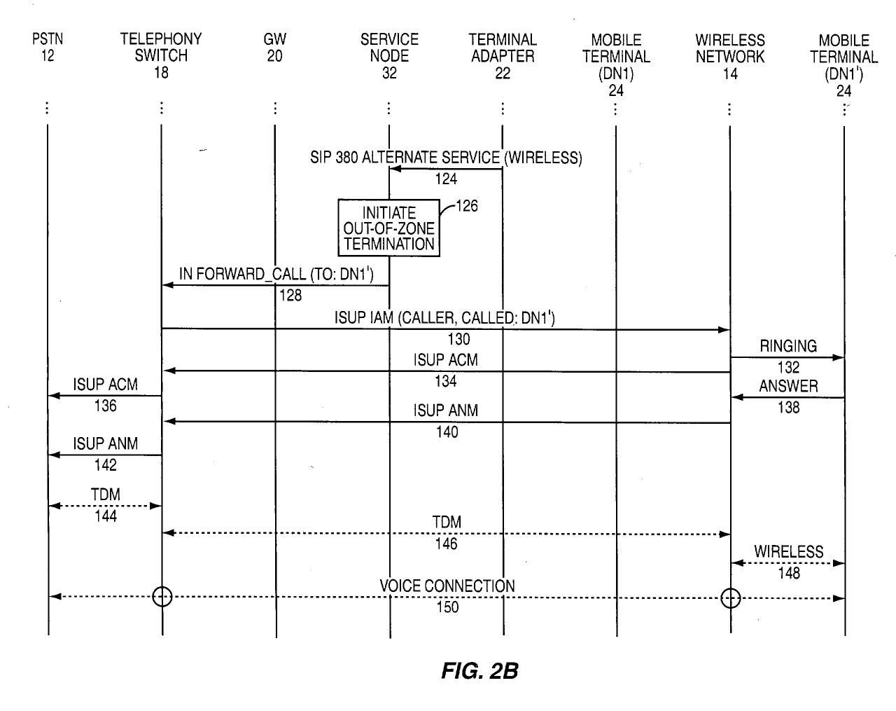

The communication call flow diagrams of FIGS. 2A and 2B provide an exemplary call flow when the mobile terminal 24 has moved out of the terminal adapter zone 26 and an incoming call is directed to the PSTN directory number, DN1, for the mobile terminal 24. The terminal adapter 22 may periodically page the mobile terminal 24 with a pre-arranged unique code (for example 2325) and wait for a response indicative of the mobile terminal 24 being within the terminal adapter zone 26 (step 100). If the mobile terminal 24 is not within the terminal adapter zone 26, the mobile terminal 24 will not receive the page, and thus, will not respond to the terminal adapter 22. If there is no response, the terminal adapter 22 will assume that the mobile terminal 24 is not within the terminal adapter zone 26. In this instance, assume that the mobile terminal 24 is within the terminal adapter zone 26, receives the paging message, and responds by sending a Hello message with the paging code to the terminal adapter 22 (step 102).

Next, assume that the mobile terminal 24 moves outside of the terminal adapter (TA) zone 26 (step 104) prior to a third party directing an incoming call to the mobile terminal 24 using the PSTN directory number DN1. As such, the PSTN 12 will forward an Integrated Services User Protocol (ISUP) Initial Answer Message (IAM) to the telephony switch 18 (step 106). The ISUP IAM will identify the called party using the PSTN directory number DN1. The telephony switch 18 is preferably provisioned to send an Intelligent Network Termination Attempt Trigger (TAT) message identifying the caller and the called party using their respective directory numbers to the service node 32 (step 108). The service node 32 will use the directory number for the called party, DN1, to recognize that the mobile terminal 24 has dual mode capability, and as such, can receive calls through multiple directory numbers (step 110).

In this embodiment, the service node 32 will initially attempt to terminate the incoming call via the PSTN using the mobile terminal's PSTN DN, DN1 (step 112). As such, the service node 32 will send a SIP Invite message identifying the caller and the PSTN directory number DN1 to the terminal adapter 22 (step 114), or an equivalent message configured to instruct the terminal adapter 22 to establish a voice connection with the telephony switch 18. The terminal adapter 22 will respond with a SIP 100 Trying message (step 116) or other message configured to let the service node 32 know that the terminal adapter 22 is attempting to establish the connection. Meanwhile, the terminal adapter 22 will determine if the mobile terminal 24 is within the terminal adapter zone 26 (step 118). The terminal adapter 22 may already know the relative presence of the mobile terminal 24 through periodic paging, or as illustrated, may initiate a paging message to the mobile terminal 24 upon receiving the SIP Invite message (step 120). Since the mobile terminal 24 has moved out of the terminal adapter zone 26, the terminal adapter 22 will eventually timeout waiting for the response to the page (step 122), and send a message back to the service node 32 indicative of the mobile terminal 24 not being within the terminal adapter zone 26 (step 124). In a SIP environment, such a message may be a SIP 380 Alternate Service Message, which may be configured to have the service node 32 attempt communications via the wireless network 14. Notably, the service node 32 may recognize the need to try the wireless network 14 automatically, or may rely on the terminal adapter 22 for such information.

At this point, the service node 32 will initiate an out-of-zone termination (step 126) by sending an Intelligent Network Forward Call message to the telephony switch 18 to direct the telephony switch 18 to forward the call to the cellular directory number DN1′ associated with the mobile terminal 24 (step 128). The telephony switch 18 will respond by sending an ISUP IAM to the wireless network 14 identifying the caller and the cellular directory number DN 1′ for the mobile terminal 24 (step 130). The wireless network 14 will trigger ringing of the mobile terminal 24 (step 132), as well as send an ISUP Address Complete Message (ACM) back to the telephony switch 18 (step 134). The telephony switch 18 will forward the ISUP ACM to the PSTN 12 (step 136). When the mobile terminal 24 is answered (step 138), the wireless network 14 will send an ISUP Answer Message (ANM) to the telephony switch 18 (step 140). The telephony switch 18 will then forward the ISUP ANM to the PSTN 12 in traditional fashion (step 142). At this point, a Time Division Multiplex (TDM) connection is established for the incoming call between the PSTN 12 and the telephony switch 18 (step 144) and between the telephony switch 18 and the wireless network 14 (step 146), and a wireless connection is established between the wireless network 14 and the mobile terminal 24 (step 148). These three connections cooperate to provide a voice connection between the caller of the PSTN 12 and the mobile terminal 24 (step 150). Call termination is performed using traditional PSTN signaling.

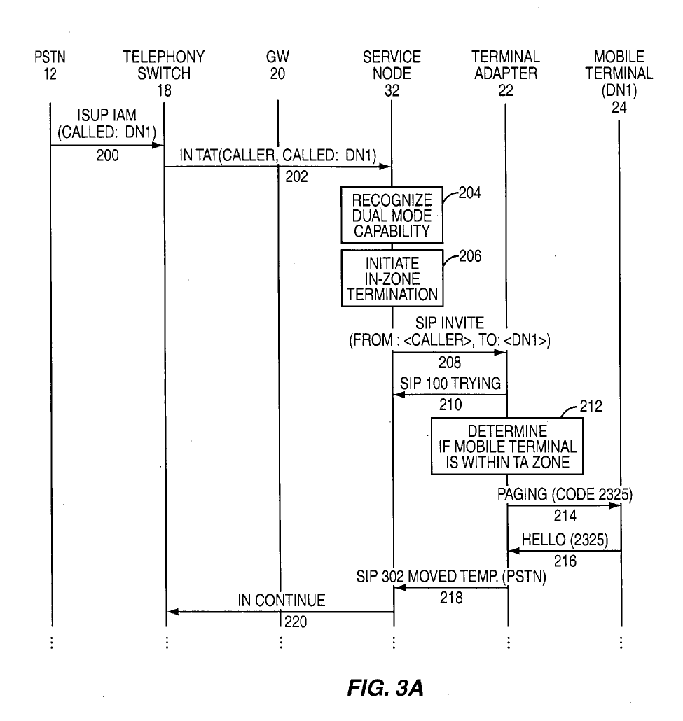

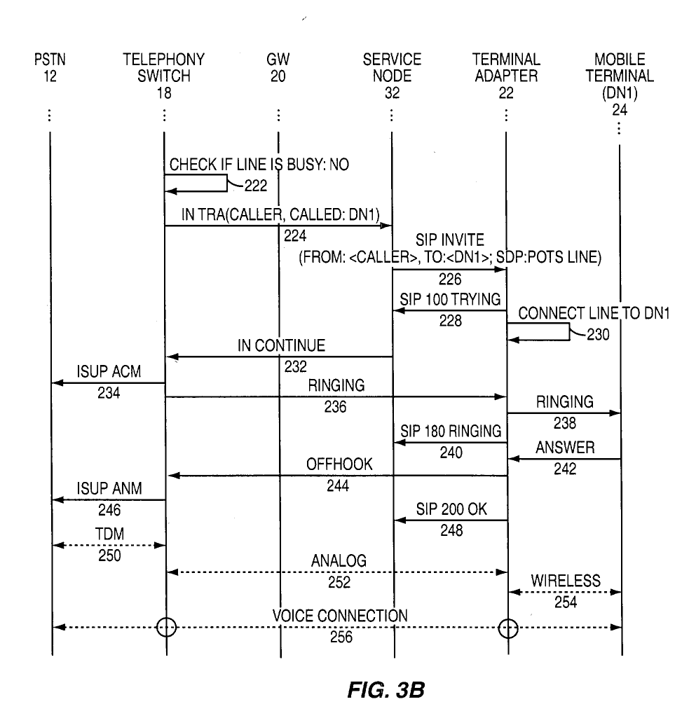

Turning now to FIGS. 3A and 3B, a communication call flow diagram is provided wherein the mobile terminal 24 is within the terminal adapter zone 26. As above, an ISUP IAM indicative of an incoming call is directed to the telephony switch 18 (step 200). The ISUP IAM will identify the called party as having a directory number DN1, which is the PSTN directory number of the mobile terminal 24. The telephony switch 18 will send an IN TAT message to the service node 32 upon receipt of the ISUP IAM (step 202). The TAT message will identify the caller, along with the directory number of the called party, DN1. The service node 32 will recognize that the mobile terminal 24 associated with the called party's directory number has dual mode capability (step 204), and will preferably initiate an in-zone termination using the PSTN directory number DN1 (step 206). As above, the service node 32 will send a SIP Invite to the terminal adapter 22 (step 208), which will respond with a SIP 100 Trying message (step 210). The terminal adapter 22 will determine if the mobile terminal 24 is within the terminal adapter zone 26 (step 212).

In this illustration, the terminal adapter 22 will send a paging message to the mobile terminal 24 upon receiving the SIP Invite message (step 214). Since the mobile terminal 24 is within the terminal adapter zone 26, it will receive and respond to the paging message by sending a response message including the paging code provided in the paging message (HELLO) (step 216). At this point, the terminal adapter realizes that the mobile terminal 24 is within the terminal adapter zone 26, and will send a message to the service node 32 indicative of the mobile terminal's presence within the terminal adapter zone 26 (step 218). In a SIP environment, this message may be a SIP 302 Move Temporary message, indicating that the mobile terminal 24 is within the terminal adapter zone 26. The service node 32 will recognize that the incoming call should be routed to the mobile terminal 24 via the PSTN directory number DN1, and will send an IN Continue message to the telephony switch 18 to so route the incoming call (step 220). Preferably, the telephony switch 18 will check and see if the telephone line connecting to the terminal adapter 22 is busy (step 222), and if it is not busy, the telephony switch 18 will send an IN Terminating Resource Available trigger (TRA) message indicating the line is not busy to the service node 32 (step 224).

The service node 32 will initiate a SIP Invite message to the terminal adapter 22 instructing it to initiate terminating the call via the telephone line (step 226). The terminal adapter 22 will respond to the SIP Invite by sending a SIP 100 Trying message to the service node 32 (step 228), and connect the telephone line via the local wireless network to the mobile terminal 24 associated with directory number DN1 (step 230). Meanwhile, the service node 32 will send an IN Continue message back to the telephony switch 18 (step 232). In response, the telephony switch 18 will send an ISUP ACM to the originating switch in the PSTN 12 (step 234), as well as sending a ringing signal to the terminal adapter 22 via the telephone line (step 236). The terminal adapter 22 will sense the ringing signal and take the necessary steps to trigger the mobile terminal 24 to ring (step 238). The terminal adapter 22 will also send a SIP 180 Ringing message to the service node 32 indicating that the mobile terminal 24 is ringing (step 240). Once the mobile terminal is answered or otherwise goes off hook (step 242), the terminal adapter 22 will sense this condition and take the necessary steps to go off hook on the telephone line, which is detected by the telephony switch 18 (step 244). The telephony switch 18 will send an ISUP ANM to the originating switch in the PSTN 12 (step 246). The terminal adapter 22 will also send a SIP 200 OK message to the service node 32 indicating that the mobile terminal 24 has been answered (step 248). At this point, a TDM connection is established between the originating switch in the PSTN 12 and the telephony switch 18 (step 250), an analog connection is established between the telephony switch 18 and the terminal adapter 22 (step 252), and a wireless connection is established between the terminal adapter 22 and the mobile terminal 24 (step 254). As such, a voice connection can be established between the caller and the mobile terminal 24 (step 256).

Notably, the presence of the gateway 20 between the telephony switch 18 and the data network 16, along with the ability of the terminal adapter 22 to communicate via the data network 16 through the data access network 28 and the data access CPE 30, allows voice over packet to be established between the telephony switch 18 and the terminal adapter 22 through the data network 16, data access network 28, and data access CPE 30, instead of directly over the telephone line. In such an embodiment, the service node 32 would provide call routing instructions to the gateway 20 as well as to the telephony switch 18 to implement the call. Further, the terminal adapter 22 may support multiple mobile terminals like the mobile terminal 24, wherein these additional mobile terminals either share the same directory numbers or have different directory numbers. Accordingly, the terminal adapter 22 will be able to keep track of the multiple mobile terminals and determine whether they are present within the terminal adapter zone 26 and report such information to the service node 32 periodically or when attempting to terminate an incoming call.

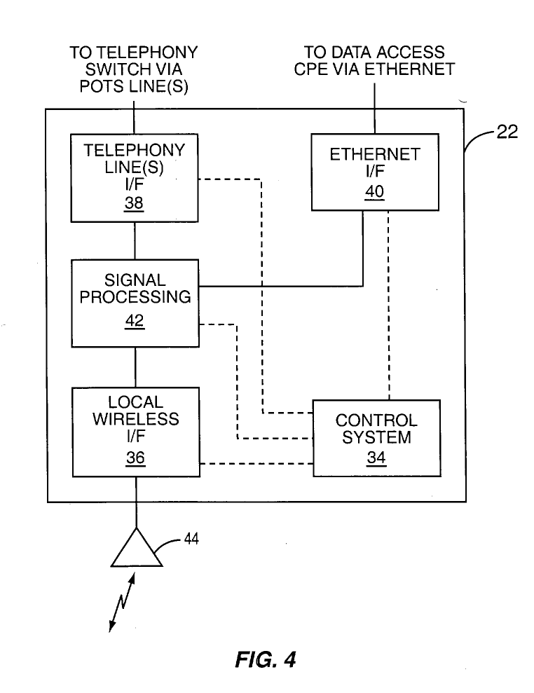

A block representation of the terminal adapter 22 is provided in FIG. 4. Preferably, the terminal adapter 22 will include a control system 34 operatively associated with a local wireless interface 36, one or more telephony line interfaces 38, an Ethernet interface 40, and a signal processing function 42. The signal processing function 42 is part of the control system 34, and is capable of providing all the necessary coding, decoding, and conversions necessary for either of the telephony line interface 38 and Ethernet interface 40 to operate with the local wireless interface 36. The local wireless interface 36 is associated with an antenna 44, and is configured to communicate wirelessly with the mobile terminal 24 using any applicable wireless technology, such as traditional analog or digital cordless technology, wireless local area network technology, including 802.11-based technologies, and Bluetooth technology. Clearly, the mobile terminal 24 must be equipped with a compatible interface and be configured to cooperate with the terminal adapter 22 to facilitate normal telephone operation. As such, the terminal adapter 22 and the mobile terminal 24 must cooperate such that the mobile terminal 24 knows when to ring, the terminal adapter 22 knows when the mobile terminal 24 has been answered or ends a call, and the mobile terminal 24 receives any caller identification or like messaging intended for the user or necessary by the mobile terminal 24 for operation. Further, the local wireless interface 36, alone or in conjunction with the control system 34, must be able to periodically or continuously detect whether the mobile terminal 24 is within communication range, and thus within the terminal adapter zone 26. Those skilled in the art will recognize numerous techniques for the mobile terminal 24 and terminal adapter 22 to cooperate with one another to determine whether or not communications are possible.

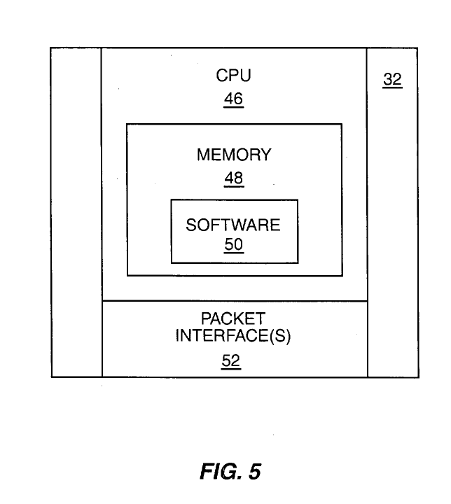

Turning now to FIG. 5, a block diagram of a service node 32 is illustrated. The service node 32 will preferably include a central processing unit (CPU) 46 having sufficient memory 48 to store the software 50 necessary for operation as described above. The CPU 46 is also associated with one or more packet interfaces 52 to facilitate communications with the terminal adapter 22 via the data network 16, as well as directly or indirectly with the telephony switch 18.

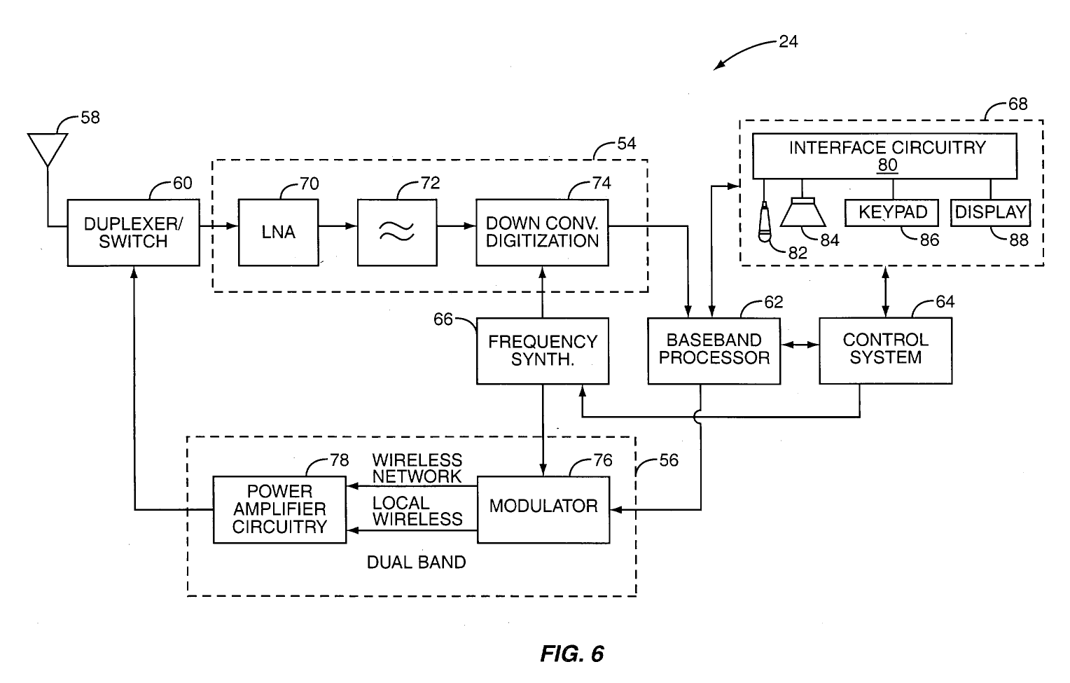

The basic architecture of the mobile terminal 24 is represented in FIG. 6 and may include a receiver front end 54, a radio frequency transmitter section 56, an antenna 58, a duplexer or switch 60, a baseband processor 62, a control system 64, a frequency synthesizer 66, and an interface 68. The receiver front end 54 receives information bearing radio frequency signals from one or more remote transmitters provided by a base station. A low noise amplifier 70 amplifies the signal. A filter circuit 72 minimizes broadband interference in the received signal, while downconversion and digitization circuitry 74 downconverts the filtered, received signal to an intermediate or baseband frequency signal, which is then digitized into one or more digital streams. The receiver front end 54 typically uses one or more mixing frequencies generated by the frequency synthesizer 66. The baseband processor 62 processes the digitized received signal to extract the information or data bits conveyed in the received signal. This processing typically comprises demodulation, decoding, and error correction operations. As such, the baseband processor 62 is generally implemented in one or more digital signal processors (DSPs).

On the transmit side, the baseband processor 62 receives digitized data, which may represent voice, data, or control information, from the control system 64, which it encodes for transmission. The encoded data is output to the transmitter 56, where it is used by a modulator 76 to modulate a carrier signal that is at a desired transmit frequency. Power amplifier circuitry 78 amplifies the modulated carrier signal to a level appropriate for transmission, and delivers the amplified and modulated carrier signal to the antenna 58 through the duplexer or switch 60.

As noted above, the mobile terminal 24 must be able to communicate with the terminal adapter 22 as well as with the wireless network 14. Accordingly, the receiver front end 54, baseband processor 62, and radio frequency transmitter section 56 cooperate to provide either a cellular interface for the wireless network 14 or the local access interface 36 for the terminal adapter 22. These functions may be implemented using redundant circuitry, or by configuring common circuitry to operate in different modes. The configuration of the mobile terminal 24 will be dictated by economics and designer choice.

A user may interact with the mobile terminal 24 via an interface 68, which may include interface circuitry 80 associated with a microphone 82, a speaker 84, a keypad 86, and a display 88. The interface circuitry 80 typically includes analog-to-digital converters, digital-to-analog converters, amplifiers, and the like. Additionally, it may include a voice encoder/decoder, in which case it may communicate directly with the baseband processor 62.

The microphone 82 will typically convert audio input, such as the user's voice, into an electrical signal, which is then digitized and passed directly or indirectly to the baseband processor 62. Audio information encoded in the received signal is recovered by the baseband processor 62, and converted by the interface circuitry 80 into an analog signal suitable for driving the speaker 84. The keypad 86 and display 88 enable the user to interact with the mobile terminal 24, input numbers to be dialed, address book information, or the like, as well as monitor call progress information. For additional information, please see concurrently filed U.S. application Ser. No. ______, entitled CALL TRANSFER FOR AN INTEGRATED WIRELINE AND WIRELESS SERVICE, the disclosure of which is incorporated herein by reference in its entirety.

Those skilled in the art will recognize improvements and modifications to the preferred embodiments of the present invention. All such improvements and modifications are considered within the scope of the concepts disclosed herein and the claims that follow.

What is claimed is:

1. A method comprising:
a) receiving information indicative of a mobile terminal being within or outside of a zone in which wireless communications between the mobile terminal and a terminal adapter are possible, the mobile terminal associated with a first directory number for which telephony communication is facilitated through a wireless network and a second directory number for which telephony communication is facilitated through a public switched telephone network, PSTN, via the terminal adaptor;
b) determining whether the mobile terminal is within or outside of the zone based on the information; and
c) instructing a telephony switch to route an incoming call for the mobile terminal through the wireless network using the first directory number when the mobile terminal is outside of the zone and through the PSTN using the second directory number when the mobile terminal is within the zone.

2. The method of claim 1 wherein the wireless network is a cellular network.

3. The method of claim 2 wherein the cellular network is based on at least one of the group consisting of TDMA, CDMA, UMTS, OFDM, and GSM.

4. The method of claim 1 wherein the mobile terminal is determined to be within or outside of the zone by querying the terminal adapter for the information upon receiving indicia of the incoming call.

5. The method of claim 1 wherein the information is periodically received from the terminal adapter.

6. The method of claim 1 further comprising receiving a first message from the telephony switch indicative of the incoming call, wherein instructing the telephony switch to route the incoming call comprises sending a second message to the telephony switch in response to the first message.

7. The method of claim 1 wherein the incoming call is intended for either the first or second directory number.

8. The method of claim 1 wherein the information is received from the terminal adapter via a packet network.

9. The method of claim 1 further comprising receiving indicia of the incoming call, determining that the incoming call is intended for the mobile terminal, and determining that the mobile terminal is associated with the first and second directory numbers.

10. The method of claim 1 wherein the mobile terminal and the terminal adapter communicate via a local wireless technology.

11. The method of claim 10 wherein the local wireless technology is a wireless local area network technology.

12. The method of claim 11 wherein the wireless local area network technology is based on 802.11 standards.

13. The method of claim 10 wherein the local wireless technology is an analog cordless technology.

14. The method of claim 10 wherein the local wireless technology is a digital cordless technology.

15. The method of claim 10 wherein the local wireless technology is a Bluetooth technology.

16. A system comprising:
a) a communication interface; and
b) a central processing unit associated with the communication interface and adapted to:
i) receive information indicative of a mobile terminal being within or outside of a zone in which wireless communications between the mobile terminal and a terminal adapter are possible, the mobile terminal associated with a first directory number for which telephony communication is facilitated through a wireless network and a second directory number for which telephony communication is facilitated through a public switched telephone network, PSTN, via the terminal adaptor;
ii) determine whether the mobile terminal is within or outside of the zone based on the information; and
iii) instruct a telephony switch to route an incoming call for the mobile terminal through the wireless network using the first directory number when the mobile terminal is outside of the zone and through the PSTN using the second directory number when the mobile terminal is within the zone.

17. The system of claim 16 wherein the wireless network is a cellular network.

18. The system of claim 16 wherein the mobile terminal is determined to be within or outside of the zone by querying the terminal adapter for the information upon receiving indicia of the incoming call.

19. The system of claim 16 wherein the information is periodically received from the terminal adapter.

20. The system of claim 16 further comprising receiving a first message from the telephony switch indicative of the incoming call, wherein instructing the telephony switch to route the incoming call comprises sending a second message to the telephony switch in response to the first message.

21. The system of claim 16 wherein the incoming call is intended for either the first or second directory number.

22. The system of claim 16 wherein the information is received from the terminal adapter via a packet network.

23. The system of claim 16 further comprising receiving indicia of the incoming call, determining that the incoming call is intended for the mobile terminal, and determining that the mobile terminal is associated with the first and second directory numbers.

24. The system of claim 16 wherein the mobile terminal and the terminal adapter communicate via a local wireless technology.

25. The system of claim 24 wherein the local wireless technology is a wireless local area network technology.

26. The system of claim 25 wherein the wireless local area network technology is based on 802.11 standards.

27. The system of claim 24 wherein the local wireless technology is an analog cordless technology.

28. The system of claim 24 wherein the local wireless technology is a digital cordless technology.

29. The system of claim 24 wherein the local wireless technology is a Bluetooth technology.

30. The system of claim 16 wherein the terminal adapter supports a plurality of mobile terminals.
